(19) United States
(12) Patent Application Publication
(10) Pub. No.: US 2009/0150173 A1
(43) Pub. Date: Jun. 11, 2009

(54) MEDICATION DISPENSING SYSTEM

(76) Inventor: George E. Riddle, Oak Ridge, TN (US)

Correspondence Address: LUEDEKA, NEELY & GRAHAM, P.C., P O BOX 1871, KNOXVILLE, TN, 37901, US

(21) Appl. No.: 11/952,512

(22) Filed: Dec. 7, 2007

(51) Int. Cl. G06Q 50/00

(52) U.S. Cl. 705/2

(57) ABSTRACT

A medication dispensing system provides convenient patient access to health care provider prescribed medications without traveling to an off-site retail pharmacy. A physician input system such as a PDA receives prescription information from the health care provider and communicates the prescription information to at least a prescription computer. The prescription computer performs at least one transaction with at least one insurance company system and subsequently determines the cash price owed by the patient for the medication. The prescription computer also causes a prescription label printer to print a prescription label to be affixed to the vial containing the filled prescription. A technician fills the prescription based on the prescription information and completes a transaction with the patient for the cash price owed on the prescription. An order computer uses the prescription information to order medications to replenish the medications prescribed from a medication wholesaler, and a report printer prints a log of the activity of the medication dispensing system.

### FIELD

This invention relates to the field of medication dispensing. More particularly, this invention relates to a medication dispensing system for use in proximity with a point of care obviating the necessity of a patient traveling to an off-site pharmacy.

### BACKGROUND

Historically, a person in need of medical attention (“patient”) visits a health care provider for an in-person examination, diagnosis, and, if deemed necessary by the health care provider, a prescription for medication to treat the diagnosed condition or disease. The prescription is typically written by the health care provider on a small sheet of paper including various information fields related to the medication such as the name of the medication prescribed, the amount of medication prescribed, the frequency with which the medication is to be ingested, applied, or otherwise administered, and whether generic medications are an acceptable alternative to the prescribed medication.

The prescription papers generally include the name of the health care provider in print, information about the health care provider such as his or her business address and telephone number, in addition to a prescription number. The health care provider must provide validation by signing the prescription and including his or her Drug Enforcement Agency (DEA) number (“prescription number”) on the prescription.

Once the health care provider has prescribed a medication to a patient, the patient typically may choose one of several pharmacies remote to the health care provider's office to have the prescription filled. A licensed pharmacist working at a pharmacy receives the prescription, follows the health care provider's orders as detailed on the prescription, and fills the prescription with the proper number of the appropriate medication. The pharmacist also provides detailed instructions for use of the medication including information describing potential side effects and information such as whether the medication is to be taken simultaneously with a meal. Additionally, the pharmacist answers any questions the patient has regarding the medication, its side effects, and the proper procedure for taking or administering the medication.

A patient's choice of pharmacy often depends on the patient's prescription medication insurance policy. Generally, pharmacies have negotiated contracts with various insurance companies and/or pharmacy benefits managers (PBMs). A prescription drug insurance provider issues a list of pharmacies engaged in a contractual relationship with the insurance provider so that its clients (patients) are able to choose a pharmacy based on the list. Typically, if a patient fills a prescription with a pharmacy not included in the prescription drug insurance provider's list of pharmacies, the insurance provider is not obligated to reimburse the patient for the prescription medication. Thus, there is a motivation for a patient to use a pharmacy approved by the insurance provider, and there is an incentive for pharmacies to negotiate contracts with various insurance providers.

However, a patient typically must leave a health care provider's office and physically travel to a pharmacy and provide the pharmacy with the prescription(s) in order for the pharmacy to begin the prescription filling process. Often a pharmacy has limited personnel available and usually only one pharmacist. Such a situation, especially if the pharmacy is very popular (for example, because of its central location), may result in a significant backlog of pharmacy customers and therefore a substantial waiting period between submittal of the prescription and filling of the prescription.

Alternatively, if the patient is a prior customer of the pharmacy, and the prescription has previously been filled at the pharmacy (for example, in the case of a refill of a prescription), the patient may place a phone call to the pharmacy to have the prescription filled. This provides the opportunity to make a time appointment so that the patient knows approximately what time the prescription will be available for pick-up. Similarly, some pharmacies provide this service via the Internet.

Another possible scenario is a health care provider with a close relationship with a pharmacy such that the health care provider may place a phone call (or otherwise submit the prescription) to the remote pharmacy to have the pharmacy begin the prescription filling process. This provides an opportunity for the patient to travel from the health care provider's office to the remote pharmacy as the pharmacy is filling the prescription.

Thus, there is a need for a pharmacy having the capability of providing prescription filling services proximate to a health care provider's place of patient examination and diagnosis. Ideally, such a pharmacy has a close interaction with the health care provider so that prescriptions are received by the pharmacy as soon as possible after the health care provider's diagnosis and prescribing of the appropriate medication(s).

### SUMMARY

The above and other needs are met by a medication dispensing system that is disposed proximate to a health care provider's office. In some embodiments, the medication dispensing system provides one or more medications prescribed by a health care provider at a pharmacy location proximate to a health care provider office. The medication dispensing system includes a prescription computer for communicating with the physician input system, receiving the prescription information, transacting with an insurance company system, and determining a monetary price owed. In some embodiments, the prescription computer includes a prescription communicator for receiving the prescription information and a processor for communicating with the prescription communicator and processing the prescription information.

In some embodiments, the medication dispensing system includes a physician input system for receiving prescription information from the health care provider and communicating the prescription information. In some embodiments, the physician input system includes an input for receiving the prescription information from the health care provider and a physician input system communicator for communicating the prescription information

In other embodiments, the physician input system is selected from the group consisting of a personal data assistant (PDA), a cellular telephone, a landline telephone, a fax machine, a laptop computer, and a personal computer. In some embodiments, the medication dispensing system includes at least one workstation for communicating with the physician input system, receiving prescription information, and communicating the prescription information to a technician.

In other embodiments, the medication dispensing system includes a report printer for communicating with the prescription computer and printing a daily log of medication dispensing system activities. In other embodiments, the medication dispensing system includes a prescription label printer for communicating with the physician input system and/or the prescription computer, receiving the prescription information and printing a prescription label based at least in part on the prescription information.

In yet other embodiments, the medication dispensing system includes an order computer for communicating with the prescription computer, receiving order information corresponding to the prescription information and placing at least one replenishment order with at least one medication wholesaler. In other embodiments, the medication dispensing system includes an electronic switch for communicating with the prescription computer and communicating over the Internet with at least one insurance company system and facilitating an insurance claim transaction between the prescription computer and the at least one insurance company system and/or PBM.

A method is disclosed for providing one or more prescribed medications at a pharmacy location proximate to a health care provider office using a medication dispensing system having a prescription computer. The method includes communicating prescription information to the prescription computer, assessing a monetary price to the patient based at least in part on the prescription information, filling a prescription based at least in part on the prescription information, and completing a transaction with the patient based at least in part on the assessed monetary price.

In some embodiments, the assessing a monetary price to the patient based at least in part on the prescription information includes performing an insurance claim transaction between the prescription computer and at least one insurance company system and determining an insurance claim amount at the prescription computer. In other embodiments, the method includes printing at least one medication label for affixing onto a filled prescription vial at a prescription label printer. In yet other embodiments, the method includes printing at least one daily report containing information related to the operating of the medication dispensing system at a report printer. In yet other embodiments, the method includes placing a medication order from an order computer communicating with the prescription computer to at least one medication wholesaler, and in other embodiments, the ordering process is performed separately and manually.

### BRIEF DESCRIPTION OF THE DRAWINGS

The invention may be best understood by reference to the detailed description when considered in conjunction with the figures, which are not to scale so as to more clearly show the details, wherein like reference numbers indicate like elements throughout the several views, and wherein:

FIG. 1 is a diagram of a medication dispensing system including its interaction with a health care provider and a patient.

FIG. 2 is a flowchart of a typical method for health care provider-patient interaction and medication dispensing.

FIG. 3 is a flowchart illustrating a method for using the medication dispensing system of FIG. 1.

FIG. 4 is a flowchart illustrating the method of FIG. 3 in additional detail.

FIG. 5 is a diagram of one embodiment of a physician input system.

FIG. 6 is a diagram of one embodiment of a prescription computer.

### DETAILED DESCRIPTION

A medication dispensing system disposed proximate to a health care provider's office provides patients convenient prescription-filling services and provides potential additional income for the health care provider. As used herein, the term “health care provider” refers to a wide variety of health care providers and health care providers' places of business or offices including, but not limited to medical doctors, doctors of osteopathy, physician assistants, hospitals, hospices, prompt care clinics, any health care professional licensed to write prescriptions, and the like. The term “proximate” when used to describe the location of the medication dispensing system refers to a location within easy walking distance of the health care provider's office. For example, a system disposed within the office of the health care provider, in the same building as a health care provider's office, in the building next door to the health care provider's office, in a building adjacent to the health care provider's office, or the like.

To distribute medications and receive reimbursement legally, a health care provider must obtain a number from either the National Council for Prescription Drug Program (“NCPDP”) or the National Association of Board of Pharmacy (“NABP”) (collectively referred to as a “pharmacy number”).

Once a health care provider has a pharmacy number, the health care provider or the health care provider's agent negotiates reimbursement contracts with one or more prescription drug insurance providers and pharmacy benefits managers (PBMs). Once such contractual agreements between the health care provider and one or more insurance companies and/or PBMs are in place, the health care provider orders appropriate medications from a medicine wholesaler or agent of the wholesaler. Such wholesalers typically sell medicines contained within manufacturer stock bottles, which are typically the same bottles that retail pharmacies receive for subsequent prescription fillings. In order to fill a prescription, an in-office pharmacist or pharmacy technician (collectively referred to herein as “technician”) distributes the medication into pharmacy vials of appropriate sizes(s) unless the medication itself is the unit of use.

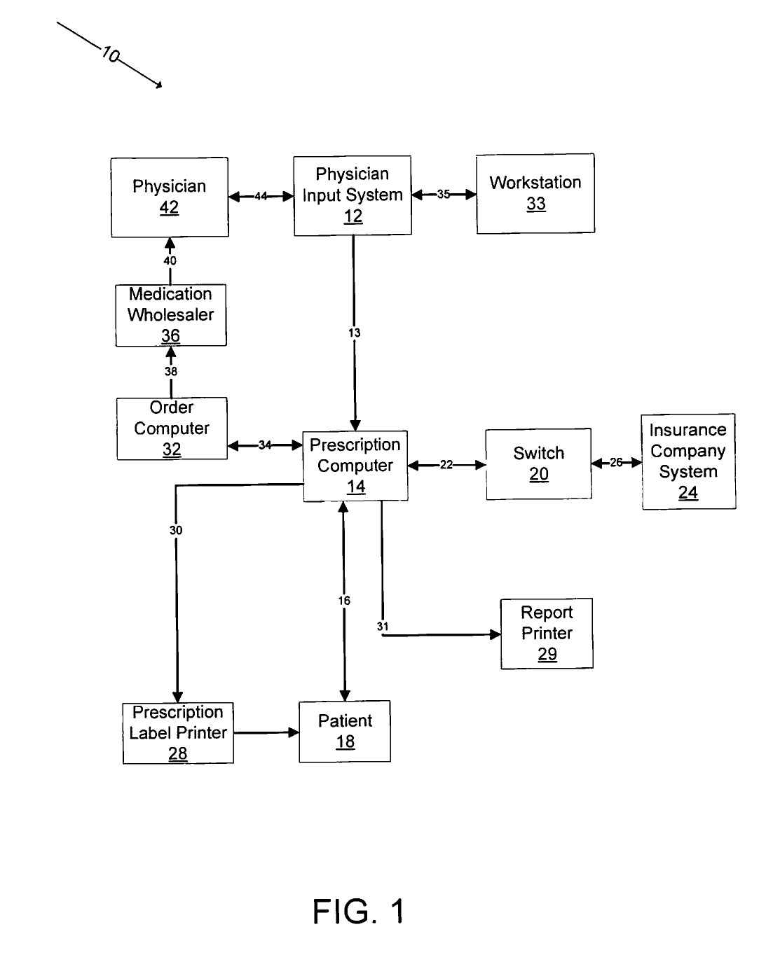

A pharmacy area of the health care provider's office or location proximate to the health care provider's office is chosen for its convenience to the health care provider's office. This allows a patient to pick up and pay for a prescription without having to travel to an off-site pharmacy. The area chosen has a work area and a storage area for medications and vials. The work area includes a lockable cabinet for scheduled (that is, controlled) medications and at least one computer, which in some embodiments has Internet access. The area also has a patient interaction location such as a desk, which is typically where the computer is located. This computer is referred to below as the prescription computer 14 in FIG. 1. Typically, the health care provider's office or location also includes access to a phone line and includes a facsimile machine.

A licensed pharmacist is not necessary in the case where the health care provider is a medical doctor or other professional authorized to prescribe medications because prescribing medications is within a medical doctor's scope of practice. However, in a handful of states, medical doctors cannot legally dispense medications, and a licensed pharmacist is necessary. In some embodiments, however, a licensed pharmacy technician is used in order to decrease potential errors in prescription filling. Further, dispensing medication is typically covered under a health care provider's malpractice insurance, but in a case where it is not, additional coverage is desirable.

In a case where a licensed pharmacist is working with the health care provider, the pharmacy may be “open.” That is, the pharmacy is allowed to receive prescriptions from outside prescription writers therefore functioning as a remote pharmacy for those prescription writers. On the other hand, in cases where no licensed pharmacist is working with the health care provider, the pharmacy must be “closed.” That is, the pharmacy is not legally able to receive prescriptions from outside prescription writers. Therefore, the pharmacy can only receive prescriptions through the medication dispensing system 10 or otherwise from the health care provider implementing the medication dispensing system 10.

Referring now to FIG. 1, a diagram of one embodiment of the medication dispensing system 10 is shown. A physician input system 12 receives input from the health care provider 42 regarding a prescription. The physician input system 12 is a personal data assistant (PDA) in some embodiments. In other embodiments, the physician input system 12 is a personal computer and in others, the physician input system 12 is a cellular telephone, a land-line telephone, a laptop computer, or other similar electronic input device. The physician input system 12 in some embodiments includes facsimile communication abilities. The health care provider 42 uses the physician input system 12 to connect to the prescription computer 14 over communication pathway 13 (also referred to as a connection).

In some embodiments, the physician input system 12 connects to a local area network (LAN) and communicates with the prescription computer 14 over the LAN, and in others, the physician input system 12 connects to the Internet and communicates with the prescription computer over the Internet. In other embodiments the physician input system 12 connects directly with the prescription computer 14 over a dedicated connection pathway 13. In some embodiments, the physician input system 12 connection 13 with the prescription computer 14 is a secure connection over which data is encrypted by way of an encryption algorithm such as a secure socket layer (SSL) encryption algorithm or other data security algorithm. In other embodiments, the connection 13 is not encrypted. In embodiments where the physician input system 12 is a wireless input device such as a PDA, a laptop computer, a personal computer, a cellular telephone or the like, connection 13 may be either a wireless connection or a wired connection.

The prescription information, in some embodiments, is a diagnosis code, which has been previously linked to the proper medication. Such link is stored at the prescription computer 14 in a database. For example, the health care provider diagnoses the patient with a common cold and enters information into the physician input system 12 necessary to communicate the diagnosis. Such information may include only an indication of a common cold or may include additional information necessary to prescribe the proper medication. The health care provider has previously correlated the diagnosis with the proper medications and stored the correlation at the prescription computer 14. Thus, the health care provider need not specifically indicate the proper medication necessary for treating the diagnosis each and every time that particular diagnosis is made. In this way, once the health care provider has provided diagnosis information to the medication dispensing system 10, the system 10 proper prescription medication is automatically provided to the patient as discussed further below.

The prescription computer 14 receives prescription information from the physician input system 12 or directly from the physician and begins the prescription filling process. The prescription computer 14, in some embodiments, is connected to a database containing patient information including insurance information. In some embodiments, the patient database is part of the prescription computer 14 and contains patient information, which may include the patient's name, address, birth date, social security number, insurance information, allergy information including drug allergy information and the like. Typically, the patient 18, upon arriving at the health care provider's office, communicates with a clerk or a pharmacy technician, having access to the patient database, either via the prescription computer 14 or another computer able to access the patient database, relevant patient information such as the information discussed above. This is represented in FIG. 1 as communication pathway 16. In other cases, the patient information is incomplete upon the prescription computer 14 receiving prescription information from the physician input system 12, and a pharmacy technician enters the appropriate patient information (collected from the patient) into the patient database at that time.

In one embodiment, the prescription computer receives information identifying the patient, such as the patient's name, from the physician input system 12, accesses the patient database, and retrieves necessary patient information. Once the patient information has been retrieved by the prescription computer or entered by the pharmacy technician into the prescription computer, the prescription computer communicates with a switch 20 over communication pathway 22. Communication pathway 22 represents any type of communication medium including a direct connection, for example via modem, or an Internet connection or the like. The switch 20 communicates with an insurance company system 24 over a communication pathway 26 such as the Internet and routes prescription information to and from an appropriate insurance company system 24. As used herein, an insurance company system 24 refers to a system of an insurance company, a PBM, or the like. The prescription computer 14 receives insurance information from the insurance company system 24 via switch 20 and determines whether the patient is entitled to discounted medications based on the insurance information. Alternatively, the insurance information received from the insurance company system 24 communicates whether the patient is entitled to discounted medications.

The pharmacy technician, in some embodiments, either accepts or rejects the transaction with the insurance company system 24 at this time. The option of whether to accept or reject the insurance transaction may be conveyed to the patient so that the patient may make the decision whether to accept or reject the transaction. If the insurance transaction requires a prescription co-pay, in some embodiments, the pharmacy technician informs the patient of such. Likewise, in some embodiments, the pharmacy technician informs the patient if the insurance company offers to pay completely for the medication. Alternatively, in some embodiments, communication with the insurance company system 24 is automatically performed upon receiving prescription information from the physician input system 12. Once the insurance information is received, the prescription computer 14 completes the transaction with the insurance company system 24 and informs either the pharmacy technician or the patient of the result of the transaction.

Once the communication or transaction between the prescription computer 14 and the insurance company system 24 is complete, the prescription computer communicates the result of the transaction to the pharmacy technician, the patient or both. The potential results include that the insurance company (I) denied the claim resulting in the patient owing the pharmacy a full cash payment for the medication, (II) accepted the claim resulting in the patient owing the pharmacy a partial cash payment for the medication, (III) accepted the claim resulting in the patient owing the pharmacy no cash payment for the medication or (IV) was unable to process the claim for some reason. If the claim was denied or did not cover the full price of the medication, the pharmacy technician may inquire whether the patient has additional prescription drug insurance coverage, in which case the pharmacy technician, through the prescription computer, manually inputs a communication with the same or another insurance company system.

As used herein the term “cash price” or “cash payment” refers to the amount owed by the patient to the health care provider for a prescribed medication and is also referred to as a “monetary price” or “monetary payment.” The monetary price is typically determined after the insurance claim determination is made and represents the amount the patient owes the pharmacy or the health care provider after the insurance claim has been considered. The monetary price is merely an amount owed and does not necessarily relate to the type of payment a patient uses to settle the monetary price. For example, if the monetary price determined after insurance claim is $100, the patient may choose to settle that amount via method of payment accepted by the pharmacy or health care provider such as credit, debit, check or cash.

Once the patient's cash payment amount is finalized, the pharmacy technician or the prescription computer communicates that amount to the patient. In some embodiments, a pharmacist or pharmacy technician works to fill the prescription in the proper amount and assemble other necessities such as appropriate instructions and medication documentation contemporaneous to the prescription computer 14 communication(s) with the insurance company system 24. Such simultaneous, efficient operation further reduces the amount of time a patient must wait for a filled prescription.

In some embodiments, the prescription computer 14 assigns an identification number to each prescription filled. This identification number is included in the label printing information in some embodiments, and in other embodiments, the prescription information is modified to include the identification number. Each subsequently assigned identification number increases in value by one. For example, when the prescription computer 14 processes one prescription, it assigns the prescription an identification number of 815. The next prescription processed by the prescription computer 14 will be assigned an identification number of 816 and so on. The identification number, in some embodiments, is communicated to the prescription label printer and is printed on the prescription label. Also, in some embodiments, the identification number is stored in the memory of the prescription computer 14.

In some embodiments, the prescription label is printed on the prescription label printer 28 upon the prescription computer 14 receiving the prescription information from the physician input system 12. Once the prescription computer 14 has received the prescription information, it communicates label information over communication pathway 30 to the prescription label printer 28. In some embodiments, a pharmacist or pharmacy technician uses the printed label as information indicating the prescription to be filled and the amount to be filled. In other embodiments, the pharmacist or pharmacy technician views the prescription information on the prescription computer 14 or views the prescription information on a workstation 33 connected to the prescription computer 14 via communication pathway 35.

In yet other embodiments, the pharmacist or pharmacy technician views the prescription information on a workstation 33 that receives the prescription information from the physician input system 12 directly, that is, the workstation 33 receives the information without the information traveling through the prescription computer 14. In such embodiments, the physician input system 12 communicates to multiple nodes in a network or directly connects to multiple computers or workstations 33 in delivering the prescription information. For example, in one configuration, the physician input system 12 communicates the prescription information directly to the prescription computer 14, the prescription label printer, one or more pharmacist workstations 33 and an order computer 32.

The order computer 32, in other embodiments, is directly connected to the prescription computer 14 over communication pathway 34 which is a LAN connection or other direct connection. The order computer 32 communicates order information over communication pathway 38 with a medication wholesaler 36 and orders prescription medications as necessary to replenish medication supplies as medications are filled for patients. Such order information is accumulated over the course a predetermined period such as a day and communicated over the Internet to the medication wholesaler in some embodiments. In other embodiments the order information is sent immediately or substantially immediately upon the health care provider entering the prescription information into the physician input system 12. Typically, medication wholesalers ship medications in bulk and therefore, the medication wholesaler, in some embodiments, accumulates the order information and ships an order accordingly. Shipment of a medication order from the medication wholesaler 36 to the health care provider 42 is represented by pathway 40.

In some other embodiments, medications are ordered manually by the pharmacy technician or other worker. In such instances, the pharmacy technician retrieves information necessary to order medications from one of the nodes in the medication dispensing system 10, for example, the prescription computer 14, the report printer 29 or the order computer 32. Then, the pharmacy technician manually orders the necessary medications from the prescription computer 14 or the order computer 32. Such manual ordering is done either via a direction connection for example via modem or is done via the Internet, for example via the medication wholesaler's website. Additionally, in some embodiments, the wholesaler's website is accessible via the Internet remote to the medication dispensing system such that the health care provider or the health care provider's agent is able to access information regarding medication orders.

In some embodiments, a report printer 29 communicates with the prescription computer 14 via communication pathway 31. The prescription computer 14 communicates a prescription profile including information regarding the medication for the patient. Alternatively, or in addition, the label printer 28 prints information about the medication to be given to the patient. In addition, the prescription computer 14 may communicate information completely detailing or summarizing a daily log of the medication dispensing system's 10 interactions for the day. Such daily log includes information regarding input from the physician input system 12, information regarding the insurance transactions for the day, information regarding orders placed for the day, and the like. In various embodiments, the report printer 29 provides numerous additional reports including insurance reports, patient profile reports, drug usage reports, order profile reports, and the like.

The pharmacist or pharmacy technician fills the prescription upon receiving prescription information from the physician input system 12. As discussed above, such prescription information is communicated to the pharmacist or pharmacy technician via the prescription computer 14, the prescription label printer 28, the report printer 29, a workstation 33 or other communication medium.

To fill the prescription, the pharmacist or pharmacy technician selects the proper stock bottle containing the prescribed medication and counts the proper quantity of medication for the prescription. Next, the pharmacist or pharmacy technician selects an empty vial and places the medication into the vial. Either after the medication has been placed in the vial or before, the label printed by the prescription label printer 28 is affixed to the vial. Auxiliary label or information is printed by the prescription label printer 28 or the report printer 29 or both. Such auxiliary labels or information may include instructions to shake well, take on an empty stomach, may cause drowsiness or other indications related to the prescribed medication. The auxiliary label(s) or information is either affixed to the vial or otherwise attached to the medication. The medication, along with its appropriate documentation is released to the patient once the insurance and/or cash transaction is completed as discussed above.

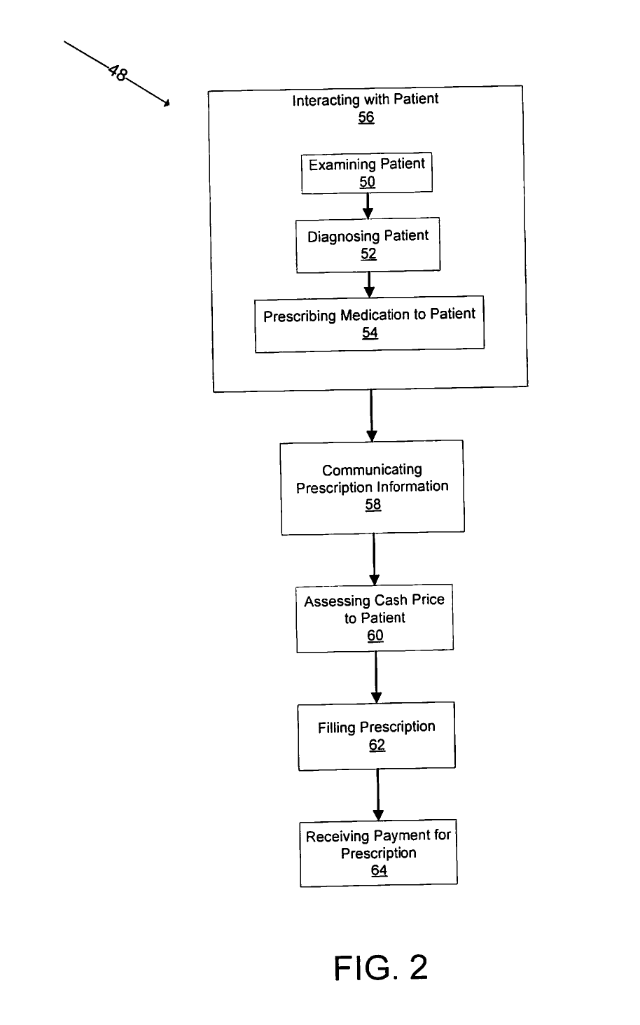

Referring now to FIG. 2, a flowchart of a generic method 48 for prescribing and filling a medication is illustrated. First, a health care provider interacts with a patient as represented by block 56. The health care provider interaction with the patient includes examining the patient as represented by block 50, diagnosing the patient as represented by block 52, and prescribing medication to the patient as represented by block 54. Next, the health care provider communicates prescription information 58 to a pharmacist or pharmacy technician. In prior art methods, such communication involved writing the prescription information on a sheet of paper, giving the sheet of paper to the patient, and the patient providing the sheet of paper to the pharmacy or pharmacy technician at a pharmacy remote to the health care provider's office. Next, the pharmacy assesses the cash price to the patient as represented by block 60. This step, in some methods, includes performing one or more transactions with one or more insurance company systems in order to determine whether an insurance claim on the medication prescribed is valid. Once the insurance claim amount is determined, the cash price to the patient is determined. Next, the prescription is filled as represented by block 62, and cash payment from the patient is received as represented by block 64.

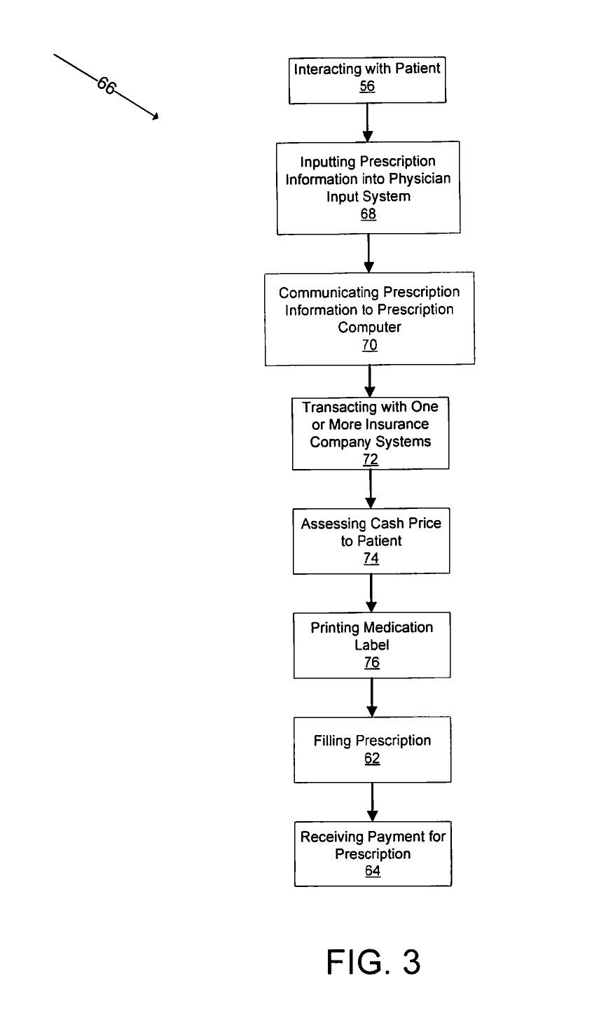

Referring now to FIG. 3, a flowchart of a method 66 for using the medication dispensing system 10 of FIG. 1 is illustrated. As with the generic method of FIG. 2, method 66 begins with interacting with a patient as represented by block 56. However, the second step of method 66 is inputting prescription information into a physician input system 12 (FIG. 1) as represented by block 68. Next, the prescription information is communicated to a prescription computer 14 (FIG. 1) as represented by block 70. As discussed above, the prescription information is also communicated elsewhere in other embodiments, such as pharmacy workstation(s), printers and the like. Next, the prescription computer 14 (FIG. 1) transacts with one or more insurance company systems as represented by block 72. Then a cash price is assessed to the patient as represented by block 74. Such cash price may be or may include a “co-pay” amount that is in addition to any insurance premium the patient has previously paid. Next, a medication label is printed as represented by block 76.

As discussed above, the prescription label printer 28 of FIG. 1 may receive the prescription information directly from the physician input system 12 in some embodiments and print the prescription labels immediately upon receiving the prescription information. In other embodiments the prescription computer 14 communicates label information to the prescription label printer 28 subsequent to receiving the prescription information. Next, the prescription is filled as represented by block 62, and the patient pays the cash price for the medication as represented by block 64. As discussed above, all of steps 72, 74, 76, 62, and 64 may be performed simultaneously or substantially simultaneously or may be performed in varying orders.

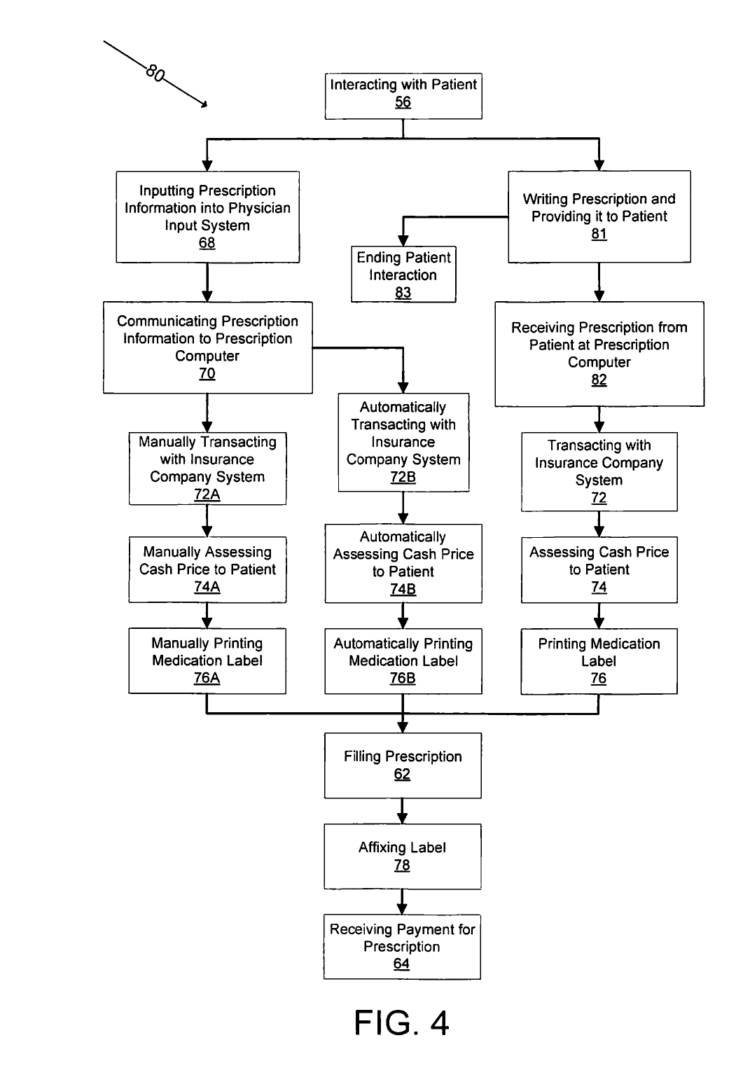

Referring now to FIG. 4, a flowchart of a comprehensive method 80 for using the medication dispensing system 10 of FIG. 1 is shown. As with the methods of FIGS. 2 and 3, the first step of method 80 is interacting with the patient 56. Next, the health care provider either writes a prescription on a sheet of paper as represented by block 81 or inputs the prescription into the physician input system 12 of FIG. 1 as represented by block 68. Following the left-hand side of the flowchart, once the health care provider has input prescription information, the next step is to communicate the prescription information to the prescription computer 14 of FIG. 1 as represented by block 70. Next, the prescription computer either automatically performs a transaction with the insurance company system as represented by block 72B or the pharmacist or pharmacy technician causes the prescription computer 14 (FIG. 1) to perform a transaction with the insurance company system as represented by block 72A on the left-hand side of the flowchart.

Continuing on the left-hand side, the next step is manually assessing the cash price to the patient as represented by block 74A. This indicates that the pharmacist or pharmacy technician receives a final decision on the insurance company transaction and determines the cash price to the patient, either by hand or using the prescription computer 14 (FIG. 1). Next, the pharmacist or pharmacy technician, using the prescription computer 14 (FIG. 1), instructs the prescription label printer 28 to print a medication label as represented by block 76A.

Referring back to the middle of the flowchart, which is one embodiment of the method for using the medication dispensing system 10 (FIG. 1), upon completion of step 72B, the next step is automatically assessing a cash price to the patient as represented by block 74B. As discussed above, this step is performed by the prescription computer automatically upon receiving final insurance transaction information in step 72B. Next, the medication label is printed automatically as represented by block 76B.

Referring to the right-hand side of the flowchart, once a prescription is written in step 81, a patient may decide to take the prescription to a remote pharmacy as represented by block 83. Alternatively, the patient decides to use the medication dispensing system 10 proximate to the health care provider's office. The next step is receiving the prescription from the patient at the prescription computer as represented by step 82. The right-hand side of the flowchart represents one embodiment of the present invention wherein the physician input system 12 (FIG. 1) is not used by the health care provider, but rather, a traditional prescription is written and the patient then carries the prescription to the in-office pharmacy (pharmacist or pharmacy technician). Next, one or more transactions with insurance company systems are performed as represented by block 72. Once the insurance transactions are finalized, the cash price is assessed to the patient as represented by block 74 and the label is printed (block 76).

Next, as shown in the flowchart, each of the three illustrated pathways converge into block 62, which represents filling the prescription. Next, the appropriate labels are affixed as represented by block 78, and cash payment is received for the prescription if necessary as represented by block 64.

Steps 72, 74, and 76 of the right-hand side of the flowchart are either manually or automatically performed as described with reference to the left-hand side and middle of the flowchart above.

In some embodiments, the prescription computer 14 of the medication dispensing system 10 flags all refills due to be filled within a predetermined period of time and communicates the same to the patient and/or the health care provider. Such communication is automatic and is preferably preformed via email.

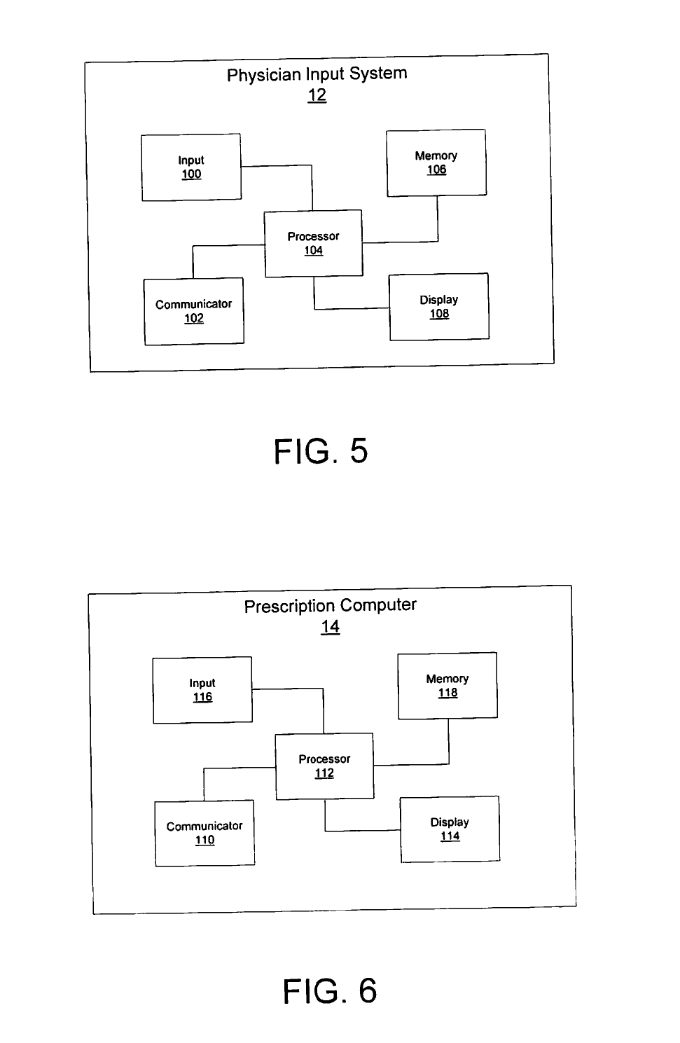

Referring now to FIG. 5, a diagram of one embodiment of a physician input system 12 is shown. The physician input system 12 has an input 100 such as a keyboard, keypad, touchscreen, audio input, any other type of human input interface or the like. The input is connected to a processor 104. The processor 104 is also connected to a communicator 102 such as a wireless module for communicating over a wireless LAN or Internet connection, other type of wireless communication device such as infrared, Bluetooth or other wireless communication protocol, a hard-wired communication module such as a network interface card for Ethernet connections, a landline telephone interface, or any other communication module. The processor 104 is also connected to a display 108 such as a monitor or other type of visible screen, a projector or any other human readable output (including a human readable audio output). Finally, in this embodiment, the processor 104 is connected to a memory 106. In other embodiments, the physician input system does not have all of the components shown in FIG. 5, for example, in one embodiment, the physician input system includes a landline telephone that does not include a processor 104 or memory 106. In yet other embodiments, the physician input system has components in addition to those shown in FIG. 5, for example, a PDA has a power supply, typically in the form of a battery.

Referring now to FIG. 6, one embodiment of the prescription computer 14 is shown. A communicator 110, such as a wireless module for communicating over a wireless LAN or Internet connection, other type of wireless communication device such as infrared, Bluetooth or other wireless communication protocol, a hard-wired communication module such as a network interface card for Ethernet connections, a landline telephone interface, or any other communication module, is connected to a processor 112. The processor 112 is also connected to an input 116 such as a keyboard or other input device. A display 114 such as a monitor or other type of visible screen, a projector or any other human readable output (including a human readable audio output) is connected to the processor 112. Finally, a memory 118 is connected to the processor 112.

Some embodiments of the prescription computer 14 do not include all of the components described with reference to FIG. 6, and other embodiments include components in addition to those described with reference to FIG. 6. For example, in some embodiments, the prescription computer 14 does not include a display 114 but rather performs its functions automatically and communicates with a workstation 33 (FIG. 1) in order to communicate with a user (technician). That is, the technician uses a workstation 33 for human input and readable display while the prescription computer 14 functions as a server without direct human interaction with the prescription computer 14. In other embodiments, for example, includes a hardware security mechanism such as a fingerprint reader so that unwanted users may not log onto the prescription computer 14.

Thus, the patient receives the prescribed medication(s) in a fraction of the time it would have taken for the patient to travel to a remote pharmacy, submit the prescription, wait for the prescription to be filled, and transact with the pharmacy to pay for the prescription. The medication dispensing system 10 also provides the health care provider the ability to monitor closely patient compliance with medication usage because the prescription transaction occurs proximately to the health care provider's office. Previously, a health care provider had no convenient way to ensure the patient received the prescribed medication in a timely fashion.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A medication dispensing system for providing one or more medications prescribed by a health care provider at a pharmacy location proximate to a health care provider office, the medication dispensing system comprising a prescription computer for communicating with the health care provider, receiving prescription information, transacting with an insurance company system, and determining a cash price owed, the prescription computer comprising:
(a) a prescription communicator for receiving the prescription information and
(b) a processor for communicating with the prescription communicator and processing the prescription information.

2. The medication dispensing system of claim 1 wherein the prescription information is manually entered into the prescription computer.

3. The medication dispensing system of claim 1 further comprising a physician input system for receiving prescription information from the health care provider and communicating the prescription information to at least the prescription computer, the physician input system comprising:
(a) an input for receiving the prescription information from the health care provider and
(b) a physician input system communicator for communicating the prescription information to at least the prescription computer.

4. The medication dispensing system of claim 3 wherein the physician input system is selected from the group consisting of a personal data assistant (PDA), a cellular telephone, a land-line telephone, a fax machine, a laptop computer, and a personal computer.

5. The medication dispensing system of claim 1 further comprising at least one workstation for receiving the prescription information, and communicating the prescription information to a technician.

6. The medication dispensing system of claim 1 further comprising a report printer for communicating with the prescription computer and at least printing a log of medication dispensing system activities.

7. The medication dispensing system of claim 1 further comprising a prescription label printer for receiving the prescription information and printing a prescription label based at least in part on the prescription information.

8. The medication dispensing system of claim 1 further comprising a prescription label printer for communicating with the prescription computer, receiving label printing information corresponding to the prescription information and printing a prescription label based at least in part on the label printing information.

9. The medication dispensing system of claim 1 further comprising an order computer for communicating with the prescription computer, receiving order information corresponding to the prescription information and placing at least one replenishment order with at least one medication wholesaler.

10. The medication dispensing system of claim 1 further comprising an electronic switch for communicating with the prescription computer and communicating with at least one insurance company system and facilitating an insurance claim transaction between the prescription computer and the at least one insurance company system.

11. A method for providing one or more prescribed medications at a pharmacy location proximate to a health care provider office using a medication dispensing system having a prescription computer, the method comprising:
(a) communicating prescription information to the prescription computer;
(b) assessing a monetary price to the patient based at least in part on the prescription information;
(c) filling a prescription based at least in part on the prescription information; and
(d) completing a transaction with the patient based at least in part on the assessed monetary price.

12. The method of claim 11 wherein step (b) comprises:
(i) performing an insurance claim transaction between the prescription computer and at least one insurance company system and
(ii) determining an insurance claim amount at the prescription computer.

13. The method of claim 11 further comprising printing at least one medication label for affixing onto a filled prescription vial at a prescription label printer.

14. The method of claim 11 further comprising printing at least one report containing information related to the operation of the medication dispensing system at a report printer.

15. The method of claim 11 further comprising placing a medication order from an order computer communicating with the prescription computer to at least one medication wholesaler.

16. An apparatus for providing one or more medications prescribed by a health care provider at a pharmacy location proximate to a health care provider office using a medication dispensing system having a prescription computer, the apparatus comprising:
(a) means for communicating prescription information to the prescription computer;
(b) means for assessing a monetary price to the patient based at least in part on the prescription information at the prescription computer;
(c) means for filling a prescription based at least in part on the prescription information; and
(d) means for completing a transaction with the patient based at least in part on the assessed monetary price.

17. The apparatus of claim 16 wherein the means for assessing a monetary price to the patient based at least in part on the prescription information at the prescription computer comprises:
(i) means for performing an insurance claim transaction between the prescription computer and at least one insurance company system and
(ii) means for determining an insurance claim amount at the prescription computer.

18. The apparatus of claim 16 further comprising means for printing at least one medication label for affixing onto a filled prescription vial at a prescription label printer.

19. The apparatus of claim 16 further comprising means for printing at least one report containing information related to the operation of the medication dispensing system at a report printer.

20. The apparatus of claim 16 further comprising means for placing a medication order from an order computer communicating with the prescription computer to at least one medication wholesaler.
